(19) United States
(12) Patent Application Publication
(10) Pub. No.: US 2025/0348893 A1
(43) Pub. Date: Nov. 13, 2025

(54) SYSTEM AND METHOD FOR VERIFIABLE INTEGRITY ASSESSMENT OF PHYSICAL OBJECTS IN A COMMERCIAL TRANSACTION LIFECYCLE

(71) Applicant: Prokta, Inc., Lewes, DE (US)

(72) Inventors: Goldee N. Udani, Bengaluru (IN); Himalaya Gupta, Bengaluru (IN)

(21) Appl. No.: 19/280,256

(22) Filed: Jul. 25, 2025

(51) Int. Cl. G06Q 30/018; G06T 7/194

(52) U.S. Cl. CPC G06Q 30/0185; G06T 7/194

(57) ABSTRACT

A system is disclosed for securely capturing, analyzing, and comparing condition-related data of physical objects during commercial transactions, such as product listings, deliveries, and returns, using AI-driven verification technologies. The system comprises a computing device having a processor, a capturing unit, at least one sensor, and a memory for storing one or more instructions executable by the processor. The system comprises a backend server that is in communication with the computing device via the network. The backend server comprises an API gateway module, a certificate authority (CA) module, a backend processing module, and a comparative analysis module. The system leverages secure cryptographic key generation and hardware-backed secure storage to establish a persistent, tamper-resistant identity for each client SDK instance. By capturing and comparing unique identifiers and flaw maps from two points in the transaction, the system can detect discrepancies or damage with forensic accuracy, providing deterministic evidence for resolving disputes.

### FIELD OF INVENTION

The present disclosure relates generally to e-commerce integrity and trust systems, and more particularly to systems and methods for securely capturing, analyzing, and comparing condition-related data of physical objects during commercial transactions, such as product listings, deliveries, and returns, using AI-driven verification technologies.

### BACKGROUND

With the rapid growth of e-commerce and recommerce (resale) marketplaces, users increasingly rely on digital platforms to buy, sell, and return physical goods without inspecting them in person. While this convenience has fueled market expansion, it has also introduced significant challenges related to trust, transparency, and fraud.

A persistent issue in online transactions is subjective or misleading representations of product condition. Sellers may upload outdated, altered, or stock images that do not reflect the actual item being shipped. This leads to disputes and dissatisfaction from buyers who receive products that differ from their expectations.

Moreover, return fraud has become a major concern. Common tactics include item swapping, false defect claims, and seller-side deception. The item swapping, where the buyer returns a different or damaged item than the one originally received. The false defect claims, where buyers intentionally damage products and claim they were received in that condition. The seller-side deception, where sellers misrepresent defective or damaged items using staged photography. These problems result in substantial losses for platforms and sellers, erode buyer trust, and overload customer service and fraud resolution teams.

To mitigate these issues, various technologies have been employed. Many platforms depend on human graders or reviewers to inspect and describe item condition before shipment. However, this method is subjective, labor-intensive, and lacks scalability. Users are prompted to upload photos during listing or return. While simple, this approach does not ensure that the images are authentic, recent, or even correspond to the item being listed or returned. Some systems track items using unique identifiers like barcodes or serial numbers. However, this method does not verify physical condition or prevent fraud through visual tampering.

Emerging platforms have started incorporating AI to assess cosmetic defects. These systems, however, often lack real-time guidance, multi-point verification, or comparative analysis capabilities between multiple capture events. Limited technologies exist for digitally signing image metadata to verify time and origin, but these often require intrusive permissions or are not tamper-proof at the user level.

Overall, existing systems fall short in offering a holistic, automated, and tamper-resistant method for capturing and verifying object integrity throughout a product's transaction lifecycle.

Therefore, there is a need for systems and methods for securely capturing, analyzing, and comparing condition-related data of physical objects during commercial transactions, such as product listings, deliveries, and returns, using AI-driven verification technologies.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a system for verifiable integrity assessment of physical objects in e-commerce transactions. The system comprises a computing device having a processor, a capturing unit, at least one sensor, and a memory for storing one or more instructions executable by the processor.

An embodiment of the first aspect, wherein the processor is configured to guide a user to capture visual data that comprises at least one of images, and videos of a physical object, and a unique identifier. The unique identifier comprises at least one of an international mobile equipment identity (IMEI), serial number, global trade item number (GTIN), or manufacturer part number (MPN) visible on the physical object. The processor is configured to obtain non-visual data that comprises at least one of motion data, device attestation signals, and a timestamp from a trusted source or a time-stamping authority.

The computing device obtains the timestamp from a network time protocol (NTP) server or a cryptographic timestamp from a time stamping authority (TSA). The processor is configured to generate at least one verifiable data package, which comprises the visual data, and the non-visual data. The computing device obtains location information, which comprises GPS coordinates or IP-derived location, and is stored as part of the verifiable data package for contextual fraud risk assessment.

An embodiment of the first aspect, wherein the processor is configured to perform a real-time quality check on the at least one verifiable data package using at least one AI model. The real-time quality check is performed using a cascade of artificial intelligence (AI) models that provide capture guidance and automatic capture triggering. The processor is configured to initiate a one-time device registration process by generating a cryptographic key pair and initiate a certificate signing request.

An embodiment of the first aspect, the system comprises a backend server that is in communication with the computing device via a network. The backend server comprises an API gateway module, a certificate authority (CA) module, a backend processing module, and a comparative analysis module.

An embodiment of the first aspect, wherein the API gateway module is configured to receive the verifiable data package and the certificate signing request from the computing device. The CA module is configured to issue a client certificate based on the certificate signing request. The client certificate is stored in the memory. The backend processing module is configured to process a device registration request and analyze the verifiable data package using artificial intelligence (AI) models to generate analysis data. The analysis data comprise generating flaw maps, condition grades, natural language descriptions, and confidence scores. The comparative analysis module is configured to compare two verifiable data packages associated with the same transaction. The backend server comprises a database that is configured to store the verifiable data package, analysis results, and certificate information

An embodiment of the first aspect, the system comprises a customer server that is configured to authenticate the computing device and retrieve analysis results from the backend server, and selectively initiate fraud resolution processes

An embodiment of the first aspect, wherein a method for verifiable integrity assessment of a physical object in a commercial transaction. At first, a cryptographic key pair is generated by the processor and a certificate signing request is submitted to the backend server. Next, the client certificate is received by the backend server from the CA module and stored in the memory in the computing device.

Next, a first verifiable data package is captured by the capturing unit i.e., a camera of the computing device. The first verifiable data package comprises images or videos of the physical object, a unique identifier associated with the physical object, and non-visual data including sensor data and device attestation signals. Next, the first verifiable data package is transmitted via the network to the backend server. The backend processing module generates an enhanced version of the images by segmenting the physical object from a background for visual clarity.

Next, the first verifiable data package is analysed using the artificial intelligence (AI) models to generate analysis data. Later, the analysis data is stored in the database and generates a verification report accessible to the customer server. The analysis data comprise generating flaw maps, condition grades, natural language descriptions, and confidence scores.

An embodiment of a second aspect, wherein a method for comparative integrity analysis of the physical object during a commercial transaction lifecycle. At first, a first verifiable data package is received during a product listing event. Next, a second verifiable data package is received during a return event. Next, unique identifiers are extracted by the backend processing module from the first verifiable data package, and the second verifiable data package. The comparative analysis module compares the extracted unique identifiers using artificial intelligence (AI) models to generate analysis data.

Next, the analysis data, derived from the first verifiable data package, and the second verifiable data package, is generated and compared by the comparative analysis module. Next, inconsistencies or mismatches in at least one of the unique identifiers, and the analysis data are flagged by the computing device. Later, a consistency report for adjudication of return or fraud assessment is generated. The backend processing module is configured to generate a confidence score and used to determine whether the consistency report requires manual analyst review. The consistency report is transmitted to an analyst portal for manual verification and adjudication.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for verifiable integrity assessment of physical objects in e-commerce transactions, in accordance with embodiments of the invention.

FIG. 2 illustrates a flowchart of a method for verifiable integrity assessment of a physical object in a commercial transaction, in accordance with embodiments of the invention.

FIG. 3 illustrates a flowchart of a method for comparative integrity analysis of an inanimate physical object during a commercial transaction lifecycle, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

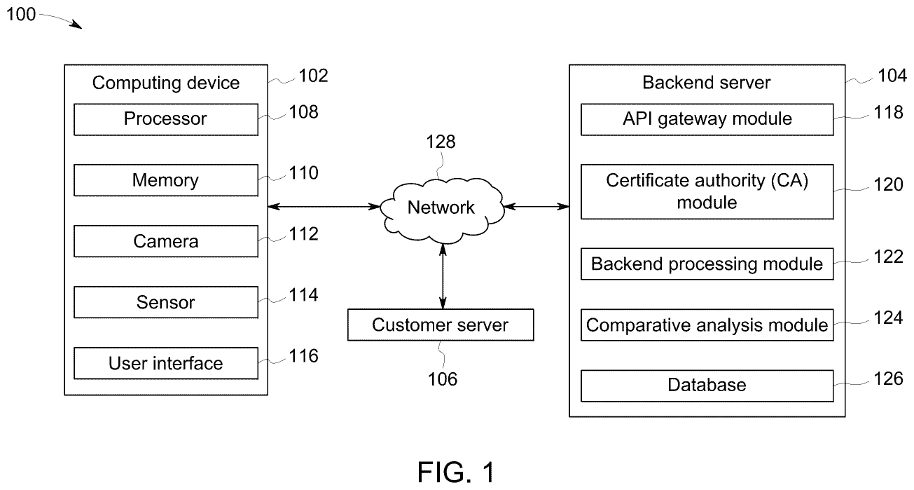

FIG. 1 refers to a block diagram of a system 100 for verifiable integrity assessment of physical objects in e-commerce transactions. The system 100 comprises a computing device 102 having a processor 108, a capturing unit 112, at least one sensor 114, and a memory 110 for storing one or more instructions executable by the processor 108.

In one embodiment herein, the system 100 comprises the computing device 102 having the processor 108 and the memory 110, which stores one or more instructions executable by the processor 108. These instructions may be executed to cause the system 100 to perform the various functionalities. The processor 108 acts as the central processing unit (CPU) of the system 100, responsible for coordinating different tasks and carrying out complex operations, data processing, and decision-making by fetching instructions from the memory 110, thereby decoding the instructions and executing the necessary actions.

In one embodiment herein, the memory 110 serves as the storage component of the system 100, holding the executable instructions, as well as any data or information required by the processor 108 to perform its tasks. The data includes user inputs, system configurations, and any other relevant data needed for the system's operations. Through the communication between the processor 108 and the memory 110, the system 100 is able to process the user inputs, access stored information, perform computations, and make decisions accordingly.

In one embodiment, the memory 110 is at least one of a secure hardware-backed storage, and a platform-native secure hardware storage.

In some embodiment, the memory 110 is a non-transitory computer-readable medium or non-transitory refers to computer-readable media that stores data for short periods or in the presence of power such as random-access memory.

In one embodiment herein, the computing device 102 represents any electronic device that the user can utilize to interact with the system 100. The computing device 102 can be, but not limited to, a smartphone, a laptop, a tablet, a personal computer, or any other suitable electronic device. The computing device 102 serves as the user's gateway to accessing and interacting with the system 100. The computing device 102 is configured to enable the user to engage with the system's functionalities and capabilities through a user interface 116.

In one embodiment herein, the user interface 116 is a crucial component of the computing device 102, which allows the users to input commands, receive information, and control the system 100. The user interface 116 can be, but not limited to, a touch screen, a keyboard, a mouse, voice recognition modules, gesture recognition sensors, and virtual reality interfaces. The versatility of the user interface 116 ensures that the users can engage with the system 100 in a manner that is most intuitive and comfortable for the users, thereby catering to a wide range of user preferences and accessibility needs. The computing device 102 empowers the users to interact with the system 100 seamlessly and efficiently by providing multiple user interface options, thereby leveraging the most appropriate input and output modalities for their specific needs and preferences.

In one embodiment herein, the computing device 102 is in communication with a backend server 104, a customer server 106 and a database 126 via a network 128. The network 128 acts as a communication that allows the computing device 102 to interact with the other components of the system 100, thereby facilitating the exchange of data, commands, and information. In one embodiment herein, the network 128 can be a wireless communication infrastructure, which offers the users flexibility and convenience when interacting with the system 100. This wireless connectivity enables the users to access the system 100 from various locations, without being tethered to a fixed physical connection.

In one embodiment herein, the network 128 can be, but not limited to, Local Area Network (LAN), Cellular Network, Wide Area Network (WAN), Intranet, Virtual Private Network (VPN), and wireless networks that use radio frequency (RF) or infrared (IR) technology to transmit data without the need for physical cables, thereby providing mobility and flexibility. The versatility of the network 128 ensures that the computing device 102 can seamlessly connect to the backend server 104 and the database 126, thereby enabling the users to access the system's 100 functionalities and resources from a variety of locations and devices. This wireless connectivity enhances the overall accessibility and convenience of the system 100 for the users.

In one embodiment, a client-side software development kit (SDK) is embedded within a customer application, which is executable on the processor 108 of the computing device 102. The customer application comprises a mobile or web application. The client-side SDK is a collection of software tools, libraries, and APIs that are embedded into a mobile or web application running on the computing device 102. The SDK allows developers to add specific functionalities such as image capture, data encryption, or AI processing-without having to build them from scratch.

In one embodiment, the processor 108 is configured to guide a user to capture visual data that comprises at least one of images, and videos of a physical object, and a unique identifier. The unique identifier comprises at least one of an international mobile equipment identity (IMEI), serial number, global trade item number (GTIN), or manufacturer part number (MPN) visible on the physical object. The processor 108 is configured to obtain non-visual data that comprises at least one of motion data, device attestation signals, and a timestamp from a trusted source or a time-stamping authority. The computing device 102 obtains the timestamp from a network time protocol (NTP) server or a cryptographic timestamp from a time stamping authority (TSA). The processor 108 is configured to generate at least one verifiable data package, which comprises the visual data, and the non-visual data. The computing device 102 obtains location information, which comprises GPS coordinates or IP-derived location, and is stored as part of the verifiable data package for contextual fraud risk assessment.

In one embodiment, the processor 108 is configured to perform a real-time quality check on at least one verifiable data package using at least one AI model. The real-time quality check in the SDK is performed using a cascade of artificial intelligence (AI) models that provide capture guidance and automatic capture triggering. The processor 108 is configured to initiate a one-time device registration process by generating a cryptographic key pair and initiate a certificate signing request. The cryptographic key pair comprises private key and public key.

In one embodiment, the system 100 comprises a backend server 104 is in communication with the computing device 102 via the network 128. The backend server 104 comprises an API gateway module 118, a certificate authority (CA) module 120, a backend processing module 122, and a comparative analysis module 124.

In one embodiment, the API gateway module 118 is configured to receive the verifiable data package and the certificate signing request from the computing device 102. The CA module 120 is configured to issue a client certificate based on the certificate signing request. The client certificate is stored in the platform-native secure hardware storage such as an Android Keystore or iOS Secure Enclave.

In one embodiment, the CA module 120 comprises certificate authority (CA) is a trusted entity that issues digital certificates-specifically, public key certificates-to verify the identity of users, devices, or software and enable secure communication over the internet or private networks.

In one embodiment, the backend processing module 122 is configured to process a device registration request and analyze the verifiable data package using artificial intelligence (AI) models to generate analysis data. The analysis data comprise generating flaw maps, condition grades, natural language descriptions, and confidence scores. The comparative analysis module 124 is configured to compare two verifiable data packages associated with the same transaction. The backend server 104 comprises the database 126 that is configured to store the verifiable data package, analysis results, and certificate information

In one embodiment, the customer server 106 is configured to authenticate the computing device 102 and retrieve analysis results from the backend server 104, and selectively initiate fraud resolution processes

In a preferred embodiment, the SDK is a secure, tamper-resistant software module integrated into the customer application. The SDK, which is executable on the processor 108 of the computing device 102, guides the user in capturing a plurality of images and videos of the physical object. Further the SDK uses on-device AI model to analyze the captured image quality in real time, collects metadata such as sensor readings, timestamps, GPS location, and encrypts, and transmits data securely to the backend server 104.

In a preferred embodiment, when the SDK is first installed and initialized on the processor 108 of the computing device 102. The SDK generates the cryptographic key pair. The SDK creates a certificate signing request (CSR) using the public key and device details.

The CA module 120 in the backend server 104 validates the CSR (e.g., using a secure token), issues and signs a client certificate using its private key, and sends the signed certificate back to the SDK, which stores it securely. The SDK then uses that certificate for mutual TLS (mTLS) communication with the backend server 104. This ensures that the backend server 104 knows it's communicating with a legitimate, registered device, and the device knows it's talking to the backend server 104.

In a preferred embodiment, the processor 108 is configured to initiate a one-time device registration process by generating the cryptographic key pair and initiate the certificate signing request. The cryptographic key pair comprises private key and public key. The processor 108 performs a multi-stage initialization and communication security process that establishes a unique, hardware-bound identity for each instance of the SDK and enables mutually authenticated, secure communication with the backend server. This process consists of, an initial brokered authentication via the customer server 106, a one-time mutual TLS (mTLS)-based device registration, and ongoing secure data exchange using the issued certificate. The customer server 106 plays a broker role in authenticating the client-side SDK before backend registration. The authentication token or credentials are validated by the backend server 104 prior to certificate issuance

In an exemplary embodiment, during first-time SDK initialization (or reinitialization following certificate expiry), the client-side SDK requires a temporary authentication token to register securely with the backend. The client-side SDK is embedded within the customer application, which is executable on the processor 108 of the computing device 102. To avoid embedding long-lived credentials within the customer application a brokered authentication flow is employed. The processor 108 initiates a request to the customer server 106. The customer server 106, which securely stores a long-lived API key or secret, forwards a request to the Backend Server's authentication endpoint. The Backend Server validates the credentials and issues a short-lived, single-use secure token (e.g., a JWT), which is returned to the customer server 106. This token is passed to the processor 108 and provided to the SDK to initiate registration.

Upon receiving the secure token, the processor 108 proceeds with device registration. A cryptographic key pair is generated locally on the computing device 102. The private key is stored in a hardware-backed secure element, such as the Android Keystore or iOS Secure Enclave. A certificate signing request (CSR), containing the public key and device-specific metadata, is created by the processor 108. The CSR is transmitted to the API Gateway module 118 of the backend server 104, authenticated using the previously issued token. The CA module 120 of the backend server 104 validates the token, processes the CSR, and acts as a private Certificate Authority (CA) to generate and sign a unique client certificate. The signed client certificate is returned to the processor 108 and stored securely on the computing device 102.

Further, using the stored client certificate and private key, the SDK initiates an mTLS handshake with the API Gateway module 118. This ensues bidirectional authentication, where the processor 108 verifies the backend server 104 verifies the specific SDK instance. All subsequent interactions, including verifiable data package uploads and retrieval of analysis results, occur over this secure channel, without reusing the brokered token.

Once the mTLS session is established, the processor 108 guides the user through the verifiable data capture process. The captured data, including visual and non-visual components, is packaged and securely transmitted to the backend server 104 over the mTLS channel. The backend server 104 receives and stores the verifiable data package and forwards it to the backend processing module 122. The backend processing module 122 analyzes the package to generate flaw maps, condition grades, and confidence scores, which are stored in the database. The backend server 104 makes the analysis results accessible to the computing device 102 and the customer server 106 through API endpoints or webhook notifications.

In one embodiment, the system 100 comprises is configured for business-to-business (B2B) inventory verification, wherein a receiving entity-such as a professional reseller or warehouse operator-validates the condition of incoming physical goods against a supplier-provided digital manifest. The system 100 receives the manifest, which includes a list of items along with their expected condition grades. Upon intake, each item is scanned using the client-side SDK embedded in the customer application, which is executable on the processor 108 of the computing device 102. The client-side SDK guides the user through a verifiable capture process and transmits the captured data to the backend. The backend processing module 122 analyzes the visual and non-visual data to generate an objective condition grade for each item. These Al-generated grades are then automatically compared with the corresponding grades listed in the supplier's manifest. Based on this comparison, the system 100 generates an intake discrepancy report, highlighting mismatches and providing verifiable evidence for dispute resolution or quality control.

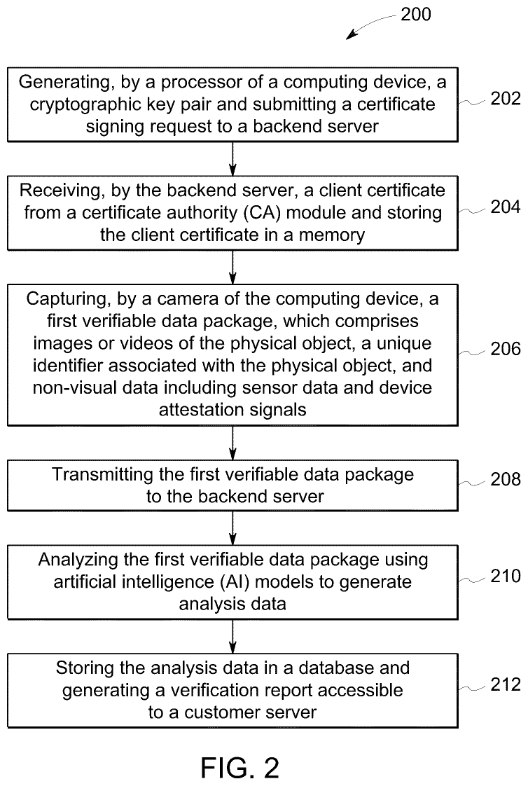

FIG. 2 refers to a flowchart 200 of a method for verifiable integrity assessment of a physical object in a commercial transaction. At step 202, a cryptographic key pair is generated by the processor 108 and the certificate signing request is submitted to the backend server 104. At step 204, the client certificate is received by the backend server 104 from the CA module 120 and stored the client certificate in the memory 110.

At step 206, a first verifiable data package is captured by the capturing unit 112 i.e., a camera of the computing device 102. The first verifiable data package comprises images or videos of the physical object, a unique identifier associated with the physical object, and non-visual data including sensor 114 data and device attestation signals. At step 208, the first verifiable data package is transmitted via the network 128 to the backend server 104. The backend processing module 122 generates an enhanced version of the images by segmenting the physical object from a background for visual clarity.

At step 210, the first verifiable data package is analyzed using the artificial intelligence (AI) models to generate analysis data. At step 212, the analysis data is stored in the database 126 and generates a verification report accessible to the customer server 106. The analysis data comprise generating flaw maps, condition grades, natural language descriptions, and confidence scores.

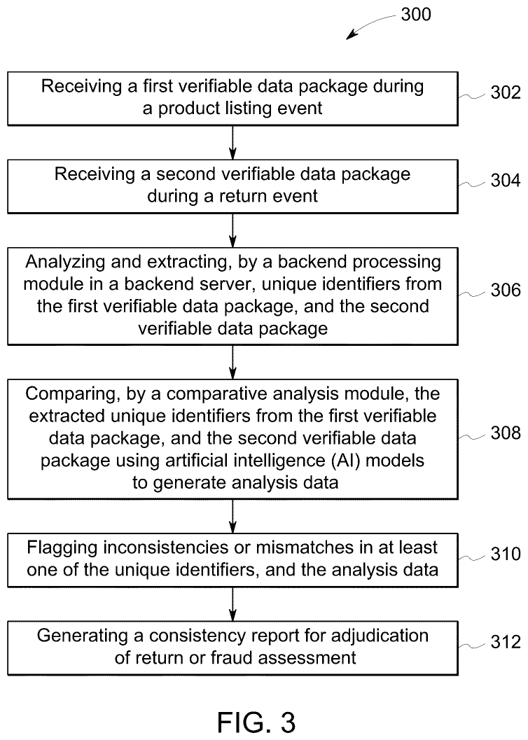

FIG. 3 refers to a flowchart 300 of a method for comparative integrity analysis of an inanimate physical object during a commercial transaction lifecycle. At step 302, a first verifiable data package is received by a seller (a first user) during a product listing event, through the computing device 102. At step 304, a second verifiable data package is received by a buyer (a second user) during a return event, through the computing device 102. At step 306, unique identifiers are extracted by the backend processing module 122 using AI-based optical character recognition (OCR) from the first verifiable data package, and the second verifiable data package.

At step 308, the comparative analysis module 124 compares the extracted unique identifiers from the first verifiable data package, and the second verifiable data package using artificial intelligence (AI) models to generate analysis data. At step 310, inconsistencies or mismatches in at least one of the unique identifiers, and the analysis data are flagged by the computing device 102. At step 312, a consistency report for adjudication of return or fraud assessment is generated. The backend processing module 122 is configured to generate a confidence score and used to determine whether the consistency report requires manual analyst review. The consistency report is transmitted to an analyst portal for manual verification and adjudication.

The system 100 uses AI models and computer vision to detect, map, and describe cosmetic flaws (e.g., scratches, dents) with a level of objectivity and consistency that is superior to manual grading. This minimizes subjectivity and creates a standardized assessment process. Through the client-side SDK, users are guided during image and video capture using real-time feedback powered by on-device AI. This ensures high-quality, verifiable captures and reduces the likelihood of user error or manipulation.

The system 100 leverages secure cryptographic key generation and hardware-backed secure storage (e.g., Android Keystore, iOS Secure Enclave) to establish a persistent, tamper-resistant identity for each client SDK instance. This enables mutual TLS (mTLS) communication and prevents spoofing. By capturing and comparing unique identifiers and flaw maps from two points in the transaction (e.g., listing and return), the system can detect discrepancies or damage with forensic accuracy, providing deterministic evidence for resolving disputes.

Verifiable data packages include visual and non-visual data (e.g., motion sensor data, attestation tokens, capture session metadata), ensuring that the captured information represents a live, unaltered view of the physical object. The SDK is designed for embedding into third-party mobile applications with minimal disruption, and the backend communicates via standard APIs and webhooks, ensuring compatibility with existing e-commerce platforms or enterprise systems.

The captured workflow can be centrally configured from the backend, allowing marketplaces to update or customize capture instructions without requiring an app update, offering greater flexibility and operational agility. The backend system and AI engine are cloud-based and capable of processing large volumes of verifiable data in parallel, enabling scalable integrity checks across thousands or millions of items.

By embedding verifiable, AI-assessed object condition data into product listings and return reports, platforms enhance transparency and trust between parties, ultimately improving customer satisfaction and reducing returns. In cases where the AI confidence score is low or potential fraud is detected, the system 100 escalates the case to human analysts via an administrative web portal, balancing automation with human oversight for high-risk scenarios.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for verifiable integrity assessment of physical objects in e-commerce transactions, comprising:
a computing device having a processor, a capturing unit, at least one sensor, and a memory for storing one or more instructions executable by the processor,
wherein the processor is configured to:
guide a user to capture visual data that comprises at least one of images, and videos of a physical object, and a unique identifier through the capturing unit;
obtain non-visual data that comprises at least one of motion data, device attestation signals, and a timestamp from either a trusted source or a time-stamping authority;
generate at least one verifiable data package, which comprises the visual data and the non-visual data;
perform a real-time quality check on the at least one verifiable data package using at least one artificial intelligence (AI) model; and
initiate a one-time device registration process by generating a cryptographic key pair and initiate a certificate signing request;
a backend server configured to communicate with the computing device via a network, wherein the backend server comprises:
an application programming interface (API) gateway module configured to receive one or more verifiable data packages and one or more certificate signing requests from the computing device;
a certificate authority (CA) module configured to issue a client certificate based on the one or more certificate signing requests;
a backend processing module configured to process a device registration request and analyze the one or more verifiable data packages using artificial intelligence (AI) models to extract unique identifiers from each of the verifiable data packages; and
a comparative analysis module configured to compare at least two verifiable data packages and the extracted unique identifiers associated with a same transaction to generate analysis data; and
a customer server configured to authenticate the computing device and retrieve analysis results from the backend server, and selectively initiate fraud resolution processes.

2. The system of claim 1, wherein the unique identifier comprises at least one of an international mobile equipment identity (IMEI), serial number, global trade item number (GTIN), or manufacturer part number (MPN) visible on the physical object.

3. The system of claim 1, wherein the real-time quality check is performed using a cascade of artificial intelligence (AI) models that provide capture guidance and automatic capture triggering.

4. The system of claim 1, wherein the client certificate is stored in the computing device.

5. The system of claim 1, wherein the analysis data comprise generating flaw maps, condition grades, natural language descriptions, and confidence scores.

6. The system of claim 1, wherein the computing device obtains the timestamp from either a network time protocol (NTP) server or a cryptographic timestamp from a time stamping authority (TSA).

7. The system of claim 1, wherein the computing device obtains location information, which comprises at least one of global positioning system (GPS) coordinates and internet protocol (IP)-derived location, and is stored as part of the verifiable data package for contextual fraud risk assessment.

8. The system of claim 1, wherein the backend server comprises a database that is configured to store the verifiable data package, analysis results, and certificate information.

9. The system of claim 1, wherein the computing device is an electronic device operated by the user to interact with the system in an uncontrolled environment.

10. A method for verifiable integrity assessment of a physical object in a commercial transaction, comprising:
generating, by a processor of a computing device, a cryptographic key pair and submitting a certificate signing request to a backend server;
receiving, by the backend server, a client certificate from a certificate authority (CA) module and storing the client certificate in a memory;
capturing, by a capturing unit of the computing device, a first verifiable data package, which comprises images or videos of the physical object, a unique identifier associated with the physical object, and non-visual data including sensor data and device attestation signals;
transmitting the first verifiable data package to the backend server;
analyzing the first verifiable data package using artificial intelligence (AI) models to generate analysis data; and
storing the analysis data in a database and generating a verification report accessible to a customer server.

11. The method of claim 10, wherein the backend processing module generates an enhanced version of the images by segmenting the physical object from a background for visual clarity.

12. The method of claim 10, wherein the analysis data comprise generating flaw maps, condition grades, natural language descriptions, and confidence scores.

13. A method for comparative integrity analysis of an inanimate physical object during a commercial transaction lifecycle, comprising:
receiving a first verifiable data package during a product listing event;
receiving a second verifiable data package during a return event;
analyzing and extracting, by a backend processing module in a backend server, unique identifiers from the first verifiable data package, and the second verifiable data package;
comparing, by a comparative analysis module, the extracted unique identifiers from the first verifiable data package, and the second verifiable data package using artificial intelligence (AI) models to generate analysis data;
flagging inconsistencies or mismatches in at least one of the unique identifiers, and the analysis data; and
generating a consistency report for adjudication of return or fraud assessment.

14. The method of claim 13, wherein the backend processing module is configured to generate a confidence score and used to determine whether the consistency report requires manual analyst review.

15. The method of claim 13, wherein the consistency report is transmitted to an analyst portal in the backend server for manual verification and adjudication.
